(19) United States
(12) Patent Application Publication
(10) Pub. No.: US 2008/0236035 A1
(43) Pub. Date: Oct. 2, 2008

(54) Lawn Edging With Offset Channel

(76) Inventors: Paul Frechette, Rutland, MA (US); Richard Brooks, Templeton, MA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/696,972

(22) Filed: Apr. 5, 2007

Related U.S. Application Data
(60) Provisional application No. 60/909,034, filed on Mar. 30, 2007.

(51) Int. Cl. A01G 1/08

(52) U.S. Cl. 47/33

(57) ABSTRACT

In general, the present invention discloses a landscape edging device for dividing distinct landscaping areas, comprising: a vertical barrier; a top portion disposed at the top of and integral to the vertical barrier; and an anchoring portion at the bottom and integral to the vertical barrier, wherein the anchoring portion in turn comprises: an offset channel formed from the vertical body and disposed on one side of the vertical body, wherein the offset channel comprises a first leg and a second leg; and an anchoring blade disposed on a second side of the vertical body and protruding from the intersection of the first leg and second leg.

### BACKGROUND OF THE INVENTION

This invention is generally directed to landscape edging to be used to separate distinct landscape sections, for example lawn from flower beds. More particularly, the invention is directed to a landscape edging device that utilizes an vertical body which forms an offset channel.

Landscape edging devices are well known in the art. Such devices are used to separate distinction landscape sections, and/or limit the growth of weeds, grass, or other plants and vegetation from encroaching on certain areas. The use of landscape edging devices can prevent the need for labor intensive manual edging, and/or the use of chemicals and other growth restricting agents in order to separate such areas and/or limit such growth.

In general, landscape edging comprises a vertical barrier that extends into the soil and rises above the ground level. The vertical barrier may comprise anchoring devices or portions at the bottom of the vertical barrier, and may include additional features at the top portion of the vertical barrier. Landscape edging devices are generally installed by a user digging or otherwise creating a trench, into which the landscape edging device is inserted. The landscape edging device is inserted into the trench with the anchoring portion located beneath ground level, and the top portion disposed above ground level. Soil may then be added around the landscape edging device to secure it in place. Alternatively, particularly stiff landscape edging may be inserted into loose soil by applying force vertically down along the edging device, thereby driving it into the soil to the desired depth.

Landscape edging devices are available in various materials, ranging from wood and metal to extruded plastic. Of these materials, extruded plastic is often more desirable, as it allows landscape edging to be manufactured in single lengths of up to and exceeding fifty (50) feet. Single lengths of landscape edging prevent the need to for joints and connections, which are often difficult to seamlessly join and can often be less than esthetically pleasing.

A drawback to single length extruded plastic landscape edging devices is packaging or arrangement in order for shipping and sale. It is known in the art to provide such landscape edging devices in a coiled arrangement in order to provide a more compact product that can be uncoiled by a user after purchase. However, in order to provide proper coiling, the thickness of the top portion of the landscape edging device and the anchoring portion must be at least close in width. If the top and anchoring sections are not close in width, a coiled product will not be maintained in the same plane and will be difficult to maintain in a coiled position at longer lengths.

Accordingly, there is a need for a landscape edging device that possess sufficient rigidity for easy insertion into soil, and has a relationship between he top portion and the bottom portion such when coiled the landscape edging device may be substantially in a single plane. Additionally, it is desirable to arrange the anchoring portion such that it proves beneficial in both its as used position in the ground, and in its coiled position during shipping and sale.

### SUMMARY OF THE INVENTION

Aspects of the invention include a landscape edging device for dividing distinct landscaping areas comprising: a vertical barrier; a top portion disposed at the top of and integral to the vertical barrier; and an anchoring portion at the bottom and integral to the vertical barrier, wherein the anchoring portion in turn comprises: an offset channel formed from the vertical body and disposed on one side of the vertical body, wherein the offset channel comprises a first leg and a second leg; and an anchoring blade disposed on a second side of the vertical body and protruding from the intersection of the first leg and second leg.

It is to be understood that both the foregoing general description and the following detailed description are exemplary and explanatory only, and are not restrictive of the invention as claimed. The accompanying drawings constitute a part of the specification, illustrate certain embodiments of the invention and, together with the detailed description, serve to explain the principles of the invention.

### BRIEF DESCRIPTION OF THE DRAWINGS

In order to assist in the understanding of the invention, reference will now be made to the appended drawings, in which like reference characters refer to like elements. The drawings are exemplary only, and should not be construed as limiting the invention.

FIG. 1 is a cross-sectional view of a landscape edging device in accordance with some embodiments of the present invention.

FIG. 2 is a composite of a side view and a cross-sectional view of a connecting tube that may be used with a landscape edging device in accordance with some embodiments of the present invention.

FIG. 3 is an pictorial view of a landscape edging product in a coiled position in accordance with some embodiments of the present invention.

### DETAILED DESCRIPTION OF THE INVENTION

Reference will now be made in detail to embodiments of the invention, examples of which are illustrated in the accompanying drawings.

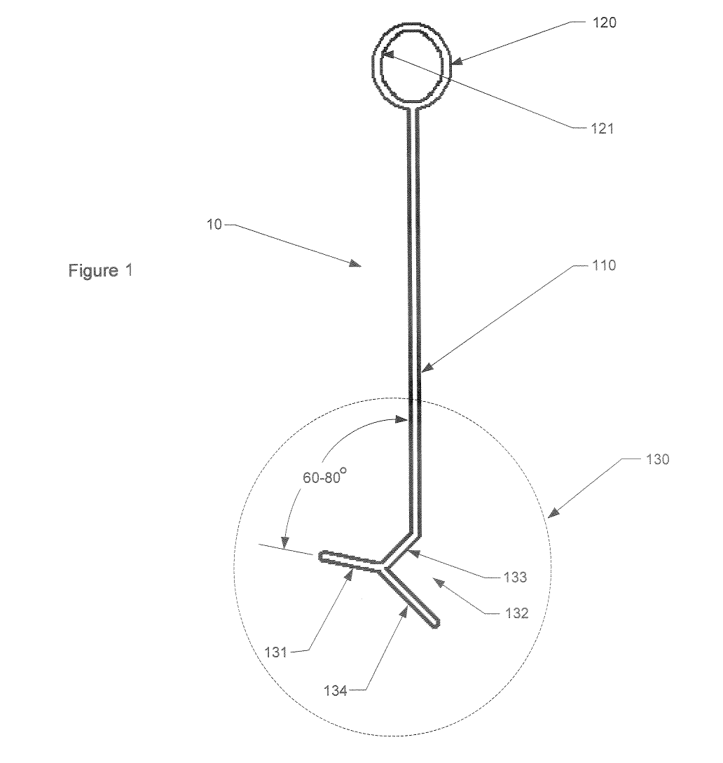

With reference to FIG. 1, a landscape edging device 10 in accordance with some embodiments of the present invention will now be discussed. The landscape edging device 10 may generally comprise a vertical body 110, a top portion 120, and an anchoring portion 130. The vertical body 110 extends between the top portion 120 and the anchoring portion 130, and may provide the dividing feature between distinct landscape sections. The vertical body 110 may be of any thickness sufficient to provide proper division and structural integrity, while still proving cost-effective and providing for ease of manufacture.

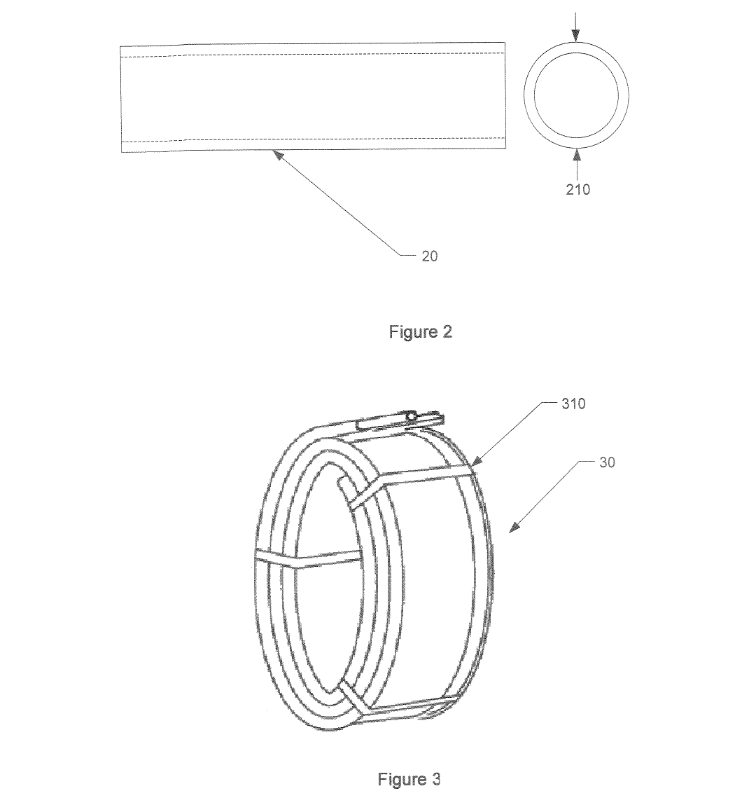

The top portion 120 may comprise a continuous, hollow member of a substantially tubular shape, comprising a particular inner diameter 121. The top portion 120 may be used to connect additional adjacent sections of edging devices. With reference to FIG. 2, a connector 20 may comprise a tubular member with a specific outer diameter 210. The outer diameter 210 of the connector 20 may be such that it can be inserted approximately half-way into the inner diameter 121 of the top portion 120 and will be maintained in position due to an interference fit. Additional adjacent sections of edging devices may be inserted over the approximate one half of the connector 20 protruding from the top portion 120 of the landscape edging device 10.

With renewed reference to FIG. 1, the anchoring portion 130 of the landscape edging device 10 will now be discussed. The anchoring portion 130 generally comprises an anchoring blade 131 and an offset channel 132 formed from the vertical body 110. As the vertical body 110 approaches the bottom of the landscape edging device 10, it may be formed into a “V” shaped channel, comprising a first leg 133 and a second leg 134. The first leg 133 and second leg 134 may form an angle ranging from forty (40) degrees to one hundred forty (1400 degrees. The anchoring blade 131 may protrude from the intersection of the first leg 133 and the second leg 134.

In order to provide ease of installation and better anchoring (i.e., in order to prevent the edging device from being accidentally or inadvertently removed, the anchoring blade 131 may be angled toward the top portion 120 approximately sixty (60) to eighty (80) degrees relative to the vertical body 110. By angling the anchoring blade 131 upward, it acts as a barb or hook, thereby prohibiting removal, while allowing for easier and more steam-lined insertion.

The offset channel 132 formed from the vertical body 110 provides numerous benefits. By modifying the vertical body itself, rather than providing additional anchoring blades, the landscape edging device may possess more rigidity, thereby allowing for easier insertion and use. Additionally, when the landscape edging device 10 is in a coiled position, the anchoring blade 131 may be disposed in the channel, thereby preventing unwanted uncoiling while maintaining the coiled product in a singe plane.

With reference to FIG. 3, the landscape edging device is illustrated in a coiled position 30. In order to maintain the product in a coiled position for shipping and sale, only the addition of banding straps 310 may be required. Multiple banding straps 310 may be used.

The landscape edging device 10 may be formed from various materials. Specifically, it is contemplated that the landscape edging device may be formed from polyethylene, including but not limited to a mixture of low density polyethylene (LDPE) and high density polyethylene (HDPE). Ratios of LDPE to HDPE may range from 10:90 to 90:10. A ratio of LDPE to HDPE of approximately 70:30 has been found to result in landscape edging devices with an adequate amount of rigidity and flexibility.

It will be apparent to those skilled in the art that various modifications and variations can be made in the method, manufacture, configuration, and/or use of the present invention without departing from the scope or spirit of the invention. For example, while the second leg 134 is illustrated in FIG. 1 as extending beyond the vertical barrier 110, this is not required. Rather, the arrangement of the first and second legs 133 and 134 of the off-set channel is to provide a channel arranged from the vertical body 110, and may comprise any arrangement.

What is claimed is:

1. A landscape edging device, comprising:
a vertical barrier;
a top portion disposed at the top of and integral to the vertical barrier; and
an anchoring portion at the bottom and integral to the vertical barrier, wherein the anchoring portion comprises:
an offset channel formed from the vertical body aid disposed on one side of the vertical body, wherein the offset channel comprises a first leg and a second leg; and
an anchoring blade disposed on a second side of the vertical body and protruding from the intersection of the first leg and second leg.

2. The landscape edging device of claim 1, wherein the top portion comprises a hollow tubular shape integral to the vertical barrier.

3. The landscape edging device of claim 2, wherein the top portion has a specified inner diameter.

4. The landscape edging device of claim 3, further comprising:
a connector, wherein the connector is of a cylindrical shape with an outer diameter sized to be inserted into the inner diameter of the top portion and to maintain in position by an interference fit.

5. The landscape edging device of claim 1, wherein the anchoring blade extends from the anchoring portion at angle between sixty (60) and eighty (80) degrees relative to the vertical body.

6. The landscape edging device of claim 1, wherein the anchoring blade extends from the intersection of the first leg and the second leg of the offset channel.

7. The landscape edging device of claim 1, wherein the first leg and the second leg of the offset channel extend from each other at an angle between forty (40) and one hundred forty (140) degrees.

8. The landscape edging device of claim 1, wherein the landscape edging device is formed from a mixture of high density polyethylene (HDPE) and low density polyethylene (LDPE).

9. The landscape edging device of claim 8, wherein the ratio of HDPE to LDPE ranges from 90:10 to 10:90.

10. The landscape edging device of claim 8, wherein the ratio of HDPE to LDPE is approximately 30:70.

11. The landscape edging device of claim 1 wherein the landscape edging device may be disposed in a coiled position, wherein the anchoring blade of one coil layer may be inserted into the offset channel of a second coil layer.

12. The landscape edging device of claim 11, further comprising at least one banding strap, wherein the at least one banding strap may wrap around a coiled landscape edging device to prevent the coiled landscape edging device from becoming inadvertently uncoiled.

13. A landscape edging device, comprising:
a vertical barrier;
a top portion comprising a hollow tubular structure disposed at the top of and integral to the vertical barrier; and
an anchoring portion at the bottom and integral to the vertical barrier, wherein the anchoring portion comprises:
an offset channel formed from the vertical body and disposed on one side of the vertical body, wherein the offset channel comprises a first leg and a second leg; and
an anchoring blade disposed on a second side of the vertical body and protruding from the intersection of the first leg and second leg, wherein the anchoring blade extends from the anchoring portion at angle between sixty (60) and eighty (80) degrees relative to the vertical body.

14. The landscape edging device of claim 13, wherein the first leg and the second leg of the offset channel extend from each other at an angle between forty (40) and one hundred forty (140) degrees.

15. The landscape edging device of claim 13, wherein the landscape edging device is formed from a mixture of high density polyethylene (HDPE) and low density polyethylene (LDPE).

16. The landscape edging device of claim 1, wherein the landscape edging device may be disposed in a coiled position, wherein the anchoring blade of one coil layer may be inserted into the offset channel of a second coil layer.
